(19) United States
(12) Patent Application Publication
(10) Pub. No.: US 2007/0241966 A1
(43) Pub. Date: Oct. 18, 2007

(54) Conductive antenna structure and method for making the same

(76) Inventor: Yung-Shun Chen, Jhongli City (TW)

Correspondence Address: TROXELL LAW OFFICE PLLC, SUITE 1404, 5205 LEESBURG PIKE, FALLS CHURCH, VA, 22041, US

(21) Appl. No.: 11/403,887

(22) Filed: Apr. 14, 2006

(51) Int. Cl. H01Q 1/38

(52) U.S. Cl. 343/700 MS

(57) ABSTRACT

A conductive antenna structure and method for making the same, wherein the method includes the following steps: (a) providing a plastic film substrate: (b) performing a rinsing coating material printing process to let the rinsing coating material position on the plastic film substrate and appear a predetermined antenna pattern; (c) performing an evaporating process for the plastic film substrate to provide a conductive layer thereon; (d) performing a rinsing process for the plastic film substrate to separate the rinsing coating material from the plastic film substrate and let the conductive layer position on the antenna pattern. Therefore, the conductive antenna structure made by the use of the above-mentioned method includes a plastic film substrate made of Polyethylene Terephthalate (PET) as well as a conductive antenna that is made of conductive material and is connected to the surface of the plastic film substrate, and has a predetermined first thickness.

### BACKGROUND OF THE INVENTION

1. Field of the Invention

The invention relates to a conductive antenna structure and method for making the same, and more particularly, to a conductive antenna structure and method for making the same that makes use of a base material made of Polyethylene Terephthalate (PET) employed in wireless radio frequency antenna.

2. Description of the Prior Art

The Radio Frequency Identification (RFID) being a system making use of wireless electromagnetic wave to transmit Identification data and the application thereof and being very widespread has the following merits:
1. Data can be updated: Unlike the conventional bar code that is unable to be updated after it is printed, RFID-TAG is capable of adding, modifying and erasing the stored data at unlimited number of times.
2. Data are easy to Identify: The conventional bar-code reader can identify only within closed distance and without any blocking objects to let the scanning light source irradiating thereon, while RFID-TAG is capable of transmitting signal as long as it is within the range of wireless electromagnetic wave.
3. High capacity in storing data: The capacity of one-dimensional bar code is 50 bytes, and the maximum capacity of a two-dimensional bar code is capable of storing 2˜3000 bytes, while the maximum capacity of RFID-TAG can reach several mega-byte.
4. It can be used repeatedly: The life of a bar-code will be ended following the life of the commodity while the RFID-TAG can be used repeatedly.
5. It can read several data at the same time: The bar-code reader can read a single bar-code data only once while the identifier of the RFID-TAG can identify and read several RFID-TAG at the same time.
6. Security: All the RFID TAG has cipher code protection in the reading respect, and high security protection measure makes it not apt to be counterfeited.

Therefore, starting from Jan. 1 of 2005, Wal-Mart, the world leading retail dealer, formally initiates a pilot testing of the RFID. What is more, the National Defense Depart of U.S.A., the Metro (the German largest franchise super market), Best Buy (the retail giant of electronic product in U.S.A.), one after another, also asks their suppliers to introduce or perform relevant RFID testing. It is estimated that the scale of RFID can reach more than 3 billion US dollars by the year of 2008, and the value of the use of the RFID TAG will reach 2.2 billion US dollars by the year of 2006.

At the present stage, the RFID has faced some bottle-neck, one of them is that the price of the RFID-TAG still stays rather high. FIG. 1 is a schematic and side view of a soft copper foil substrate structure of the prior art. As shown in FIG. 1, the conventional soft copper foil substrate (FCCL) employs Polyimide (PI) (11) as base material, and after its two side surfaces are coated with adhesive (12) respectively, they are each stuck with a layer of copper foil respectively. Afterwards, they are made by the etching method to fabricate into the conventional high cost soft copper foil substrate (FCCL) to etch the copper foil (13) into a shape of conductive antenna structure. This kind of fabricating method is not appropriate for fast mass-production due to the tended high unit price since the material cost is relatively high and the fabricating process is rather complicated. Besides, the waste liquids generated will do harm to the environment, and the waste liquid treatment will cost a lot. Therefore, oftentimes it is very hard to consider together all of the factors such as process cost, throughput efficiency, and flexibility. The price of the raw material and the cost of process of the conventional etching copper-foil substrate are very high. The conventional antenna technology developed by the above-mentioned etching copper-foil substrate is made by printing vacuum electroplating and rinsing. Guided by the subject of lowering the TAG price to develop the market acceptance, one can obtain one of the methods of obtaining the advantage of competitiveness on the market. This method is to replace above-mentioned conventional antenna technology to lower the cost in great extent in order to meet the needs and trend of the market in the hope that the technology of fabricating the tag antenna can extend to other relevant industrial applications.

### SUMMARY OF THE INVENTION

In light of the above-mentioned disadvantages of the prior arts, the invention aims to ameliorate at least some of the disadvantages of the prior art or to provide a useful alternative.

The primary objective of the invention is to provide a conductive antenna structure and method for making the same wherein the conductive antenna made by using the plastic film as a substrate and by the use of evaporating and rinsing methods has the advantages of effectively lowering the manufacturing cost, improving the throughput efficiency, and having production flexibility.

The secondary objective of the invention is to provide a conductive antenna structure and method for making the same, wherein the manufacturing method is pertinent in production automation of industrial management and is high in efficiency. Besides, the products produced by the manufacturing process of the invention are good in flexibility, and are light in weight, and thin, short, and small in dimension. What is more, the employed material conform the regulation of environmental protection.

The another objective of the invention is to provide a conductive antenna structure and method for making the same, wherein the circuit pattern made by the invention is capable of applying in conductive circuit of relevant electronic products such as Radio Frequency (RF) and Flexible Printed Circuit (FPC).

To achieve the above-mentioned objectives, the invention provides a conductive antenna structure and method for making the same wherein the method includes the following steps: (a) providing a plastic film substrate: (b) performing a rinsing coating material printing process to let the rinsing coating material position on the plastic film substrate and appear a predetermined antenna pattern; (c) performing an evaporating process for the plastic film substrate to provide a conductive layer thereon; (d) performing a rinsing process for the plastic film substrate to separate the rinsing coating material from the plastic film substrate and let the conductive layer position on the antenna pattern. In addition, the conductive antenna structure made by the use of the above-mentioned method includes a plastic film substrate made of Polyethylene Terephthalate (PET) as well as a conductive antenna that is made of conductive material and is connected to the surface of the plastic film substrate, and has a predetermined first thickness.

To achieve the above-mentioned objectives, the invention also provides an apparatus for making conductive antenna structure, the apparatus includes a photogravure coater, an evaporator, and a rinsing machine. The photogravure coater is capable of receiving a plastic film substrate and forming into a printed substrate therefrom, and the printed substrate has a rinsing coating material positioned on the plastic film substrate and appears a predetermined antenna pattern. The evaporator is for receiving the printed substrate and evaporating a conductive layer on the printed substrate. The rinsing machine is for receiving the printed substrate that has a conductive layer evaporating thereon, and forming the printed substrate into a rinsing substrate; the rinsing substrate removes the rinsing coating material and the conductive layer provided on the rinsing coating material from the rinsing substrate

The accomplishment of this and other objectives of the invention will become apparent from the following description and its accompanying drawings of which:

### BRIEF DESCRIPTION OF THE DRAWINGS

FIG. 1 is a schematic and side view of a soft copper foil substrate structure of the prior art;

FIG. 2A through FIG. 2D are schematic side views showing the method for making the conductive antenna of the preferred embodiment of the invention;

FIG. 3 is a schematic view showing the disposition of the method for making the conductive antenna of the preferred embodiment the invention.

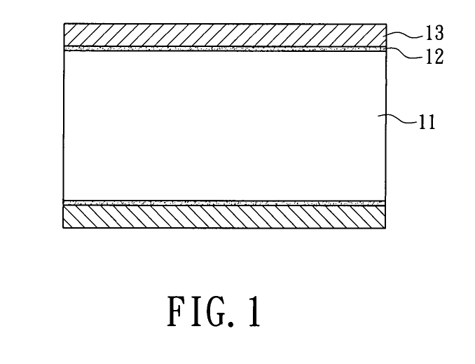

### DETAILED DESCRIPTION OF THE PREFERRED EMBODIMENT

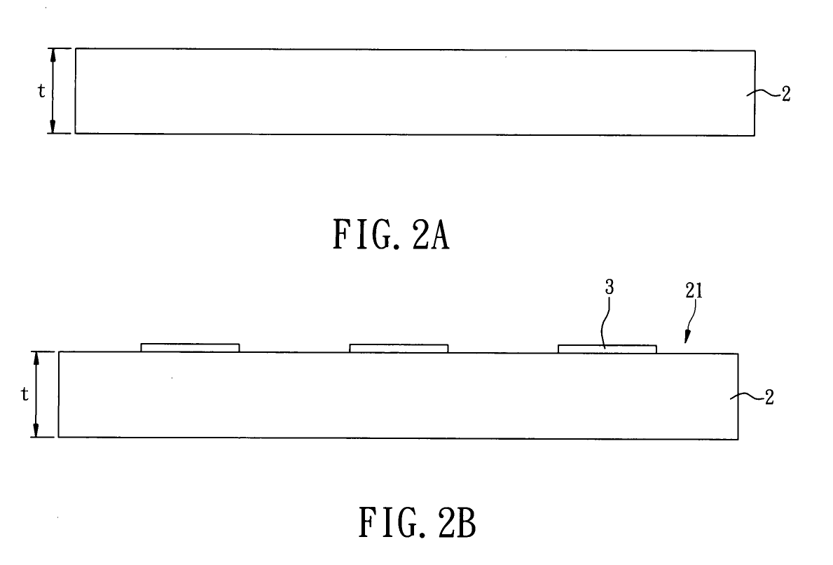

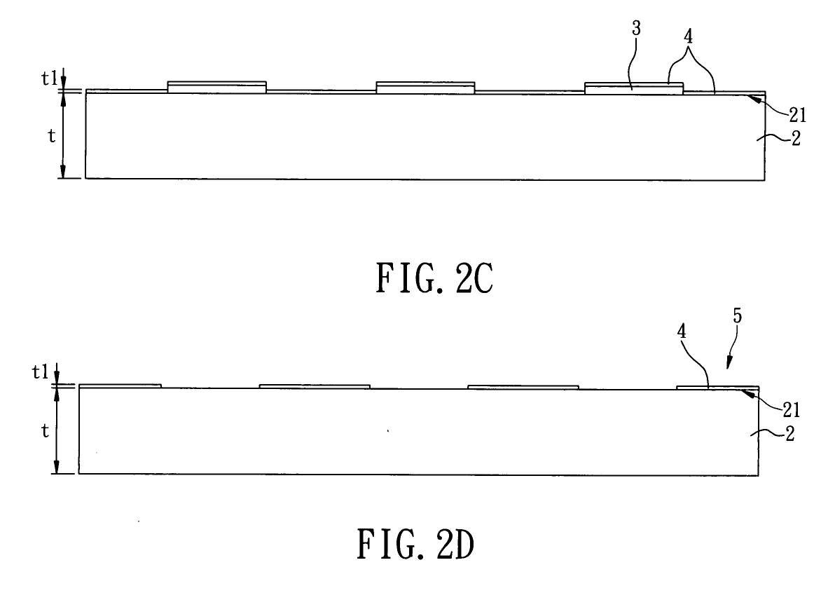

FIG. 2A through FIG. 2D are schematic side views showing the method for making the conductive antenna of the preferred embodiment of the invention. As shown in FIG. 2A, the method for making the conductive antenna of the invention provides a plastic film substrate (2) made of Polyethylene Terephthalate (PET) which is generated by the combination of terephthalic acid and ethylene alcohol. The PET plastic is adopted because it has the following characteristics: 1. High durability and transparency—good heat-resistance and heat-insulation and having high transparency; 2. Beneficial to environmental protection: PET is an environmental protection plastic material that can replace PVC (Polyvinyl Chloride) plastic which is harmful to the environment; 3. It can be recycled: PET plastic being a most valuable material in recycling can be recycled and reprocessed into manmade fiber or secondary processed plastic products; 4. It is light in weight, impact durable, and not apt to crack.

The plastic film substrate (2) includes a second thickness (t) that is between 6˜188 micrometer (6 μm˜188 μm). The preferred embodiment of the invention also designs a circuit to perform photogravure imposing process operation, the normally used photogravure imposing process includes: 1. Carved plate processing having depth of 30 μm˜80 μm (board copper plating→grinding→carving→chromium plating→grinding). 2. Etching plate processing having depth of 15 μm˜80 μm (board copper plating→coating→exposure→etching→rinse→chromium plating→grinding). 3. Laser plate processing having depth of 15 μm˜80 μm (board copper plating→coating→Laser→etching→rinse→chromium plating→grinding).

As shown in FIG. 2B, the plastic film substrate (2) after performing the rinsing coating material (3) prints out the designed circuit making the rinsing coating material (3) has a predetermined antenna pattern (21). Consequently, the antenna pattern (21) appears hollowed out by chiseling thereat. The thickness of the rinsing coating material (3) is anywhere between 1 micro-meter 3 micro-meter (1 μm˜3 μm). Certainly, in order to enhance the bondability between the rinsing coating material (3) and the plastic film substrate (2) of the invention, one can coat a base material primer of on the plastic film substrate (2) beforehand. Thereby, in the next manufacturer process, the bondability of a conductive layer (4) on the plastic film substrate (2) can enhance at the same time. Of cause, the base material primer can coat on the antenna pattern (21) and the rinsing coating material (3) after printing the rinsing coating material (3). Since the rinsing coating material (3) contains liquid content, the plastic film substrate (2) needs to perform drying process to remove the solvent's liquid content of the plastic film substrate (2), then make the plastic film substrate (2) form a scroll.

As shown in FIG. 2C, the plastic film substrate (2) is performed evaporating process to have the antenna pattern (21) and rinsing coating material (3) provided a conductive layer (4) made of copper or aluminum. In the preferred embodiment of the invention, before performing the conductive layer (4), the plastic film substrate (2) is performed corona process to generate polarization on the surfaces of the antenna pattern (21) and the rinsing coating (3). The corona process is an electric shock process that causes the surface to be printed to have a relatively higher adhesion. The generation of corona process is to generate electric shock for the earth and electric-induced air nozzle by the use of high-voltage and high-frequency while there is no current passed between them until the voltage is as high as 3,000˜5,000 volt/square meter. Afterward, the electrically shocked molecules project out of the air nozzle, and the ionized electrons with high-energy dash toward the anode, and the corona process is this action generated by the high density and high energy projecting ions. By means of the electric shock and permeation, these ions enter the surface to be printed and break its molecular structure, and further oxidize and polarize the molecules on the surface to be treated. By making use of the ion to electrically shock to corrode the surface to be printed, the adhesion to the surface is enhanced.

Finally, as shown in FIG. 2D, the plastic film substrate (2) is performed rinsing process to make the rinsing coating (3) separate from the plastic film substrate (2). In the meantime, the conductive layer (4) forms a conductive antenna having a predetermined first thickness (t1), preferably at least 0.1 micrometer (0.1 μm). The finished plastic film substrate (2) is then performed drying process to remove the solvent's liquid content and formed a scroll.

Referring again to FIG. 2D, the conductive antenna structure of the invention as stated above includes a plastic film substrate (2) and a conductive antenna (5). The plastic film substrate (2) is made of Polyethylene Terephthalate (PET) and the second thickness is anywhere between 6 micro-meter 188 micro-meter (6 μm˜188 μm). Besides, the conductive antenna (5) is the conductive layer (4) that is made of conductive material, and is provided on the antenna pattern (21). The conductive antenna (5) is connected to the surface of the plastic film substrate (2) with the first thickness (t1) with at least 1 micro-meter (1 μm).

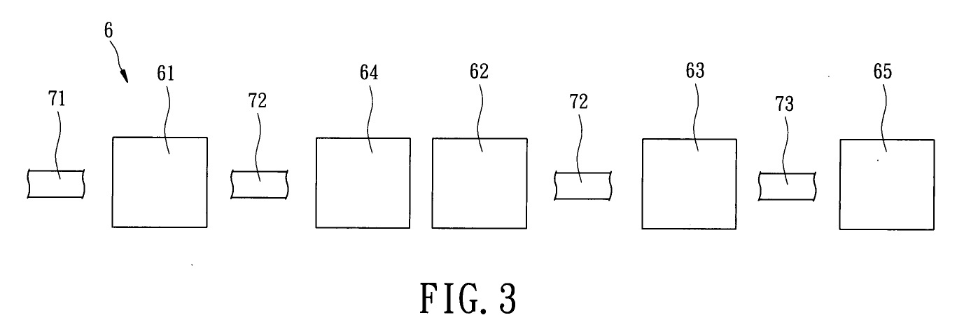

FIG. 3 is a schematic view showing the disposition of the method for making the conductive antenna of the preferred embodiment the invention. As shown in FIG. 3, the apparatus (6) for making the conductive antenna of the invention includes a photogravure coater (61), an evaporator (62), and a rinsing machine (63). The photogravure coater (61) is capable of receiving a plastic film substrate (71) that is formed into a printed substrate (72). The printed substrate (72) having rinsing coating material is positioned on the plastic film substrate (71) and appears a predetermined antenna pattern (not shown in the Figure). The evaporator (62) receives the printed substrate (72) and evaporates a layer of conductive layer thereon (not shown in the Figure). The rinsing machine (63) receives the printed substrate (72) (that is evaporated a layer of conductive layer thereon) and forms into a rinsing substrate (73) that removes the conductive layer provided on the rinsing coating material (3) of the printed substrate (72).

In the preferred embodiment of invention, the apparatus (6) for making the conductive antenna (5) further includes a first dryer (64) and a second dryer (65). The first dryer (64) being positioned between photogravure coater (61) and the evaporator (62) is capable of receiving the printed substrate (72) and removing the solvent's liquid content of the printed substrate (72).

It will become apparent to those people skilled in the art that various modifications and variations can be made to the structure of the invention without departing from the scope or spirit of the invention. In view of the foregoing description, it is intended that all the modifications and variation fall within the scope of the following appended claims and their equivalents.

What is claimed is:

1. A method for making the conductive antenna comprising the following steps:
(a) providing a plastic film substrate:
(b) performing a rinsing coating material printing process to let the rinsing coating material position on the plastic film substrate and appear a predetermined antenna pattern;
(c) performing evaporating process for the plastic film substrate to provide a conductive layer thereon; (d) performing a rinsing process for the plastic film substrate to separate the rinsing coating material from the plastic film substrate and let the conductive layer position on the antenna pattern.

2. The method for making the conductive antenna as claimed in claim 1, wherein the process after the step (a) further includes a step (a1) to perform a photogravure imposing process.

3. The method for making the conductive antenna as claimed in claim 1, wherein the process after the step (b) further includes a step (b1) to perform a drying process for the plastic film substrate to remove the solvent's water content of both of the rinsing coating material and the plastic film substrate; in the meantime to make the plastic film substrate form a scroll.

4. The method for making the conductive antenna as claimed in claim 1, wherein the method after the step (b) further includes a step (b2) to perform a corona process to generate polarization on the surface of the plastic film substrate and the rinsing coating material.

5. The method for making the conductive antenna as claimed in claim 1, wherein the method after the step (d) further includes a step (d1) to perform a drying process to remove the solvent's water content for the conductive layer and the plastic film substrate, afterward the plastic film substrate forms a scroll.

6. The method for making the conductive antenna as claimed in claim 1, wherein the conductive layer in step (c) is made of copper.

7. The method for making the conductive antenna as claimed in claim 1, wherein the conductive layer in step (c) is made of aluminum.

8. A conductive antenna structure comprising:
a plastic film substrate made of Polyethylene Terephthalate (PET); and
a conductive antenna being made of conductive material, connected to the surface of the plastic film substrate, and having a predetermined first thickness.

9. The conductive antenna structure as claimed in claim 8, wherein the plastic film substrate has a second thickness, and the second thickness is anywhere between 6 micro-meter 188 micro-meter (6 μm˜188 μm).

10. The conductive antenna structure as claimed in claim 8, wherein the plastic film substrate has a first thickness that is more than 0.1 micro-meter (0.1 μm).

11. An apparatus for making conductive antenna structure comprising:
a photogravure coater being capable of receiving a plastic film substrate and forming into a printed substrate therefrom, and the printed substrate has a rinsing coating material positioned on the plastic film substrate and appears a predetermined antenna pattern;
an evaporator for receiving the printed substrate and evaporating a conductive layer on the printed substrate; and
a rinsing machine for receiving the printed substrate that has a conductive layer evaporating thereon, and forming the printed substrate into a rinsing substrate that is capable of removing, from the rinsing substrate, the rinsing coating material and the conductive layer provided on the rinsing coating material.

12. The apparatus for making conductive antenna structure as claimed in claim 11 further comprising at least a dryer that is capable of receiving the printed substrate and removing the solvent's liquid content on the printed substrate.

13. The apparatus for making conductive antenna structure as claimed in claim 11 further comprising at least a dryer that is capable of receiving the rinsing substrate and removing the solvent's liquid content on the rinsing substrate.

14. The apparatus for making conductive antenna structure as claimed in claim 11, wherein the plastic film substrate is made of Polyethylene Terephthalate (PET).

15. The apparatus for making conductive antenna structure as claimed in claim 11, wherein the plastic film substrate has a second thickness, and the second thickness is anywhere between 6 micro-meter˜188 micro-meter (6 μm˜188 μm).

16. The apparatus for making conductive antenna structure as claimed in claim 11, wherein the plastic film substrate has a first thickness, and the first thickness is more than 0.1 micro-meter (0.1 μm).
